(19) United States
(12) Patent Application Publication
(10) Pub. No.: US 2017/0263168 A1
(43) Pub. Date: Sep. 14, 2017

(54) APPARATUS, METHOD, AND NON-TRANSITORY MEDIUM STORING PROGRAM FOR IMAGE DISPLAY

(71) Applicant: FUJITSU LIMITED, Kawasaki-shi (JP)

(72) Inventor: Yasuo MATSUMIYA, Hadano (JP)

(73) Assignee: FUJITSU LIMITED, Kawasaki-shi (JP)

(21) Appl. No.: 15/408,720

(22) Filed: Jan. 18, 2017

(30) Foreign Application Priority Data
Mar. 10, 2016 (JP) 2016-047509

(51) Int. Cl. G09G 3/02; G09G 5/10; G09G 3/34

(52) U.S. Cl. CPC G09G 3/02; G09G 3/346; G09G 5/10; G09G 3/3406; G02B 5/208

(57) ABSTRACT

An apparatus for image display includes: a drawing circuit configured to carry out drawing processes which include irradiating a retina with light through a pupil; a detector configured to detect scattered light generated due to reflection of light emitted by the drawing circuit around the pupil; and a stopping circuit configured to stop the drawing processes performed by the drawing circuit for a given period when the scattered light is detected by the detector.

### CROSS-REFERENCE TO RELATED APPLICATION

This application is based upon and claims the benefit of priority of the prior Japanese Patent Application No. 2016-047509, filed on Mar. 10, 2016, the entire contents of which are incorporated herein by reference.

### FIELD

The present embodiments discussed herein are related to an apparatus, a method, and a non-transitory medium storing a program forimage display.

### BACKGROUND

An apparatus for image display (e.g. retina drawing and displaying) that draws and displays an image by irradiating the retina surface with light has been disclosed. As examples of the related art, Japanese Laid-open Patent Publication No. 2006-189573, Japanese Laid-open Patent Publication No. 2014-102368, Japanese Laid-open Patent Publication No. 2005-292191, Japanese National Publication of International Patent Application No. 2003-513333 are known.

### SUMMARY

According to an aspect of the embodiment, an apparatus for image display includes: a drawing circuit configured to carry out drawing processes which include irradiating a retina with light through a pupil; a detector configured to detect scattered light generated due to reflection of light emitted by the drawing circuit around the pupil; and a stopping circuit configured to stop the drawing processes performed by the drawing circuit for a given period when the scattered light is detected by the detector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram that exemplifies an overall configuration of an apparatus for image display (e.g. retina drawing and displaying) according to embodiment example 1, and FIG. 1B is a diagram that exemplifies disposing of an apparatus for image display;

FIG. 2A and FIG. 2B are diagrams that exemplify irradiation with drawing light;

FIG. 3A and FIG. 3B are diagrams that exemplify scattered light detection mechanisms included in a scattered light detector;

FIG. 4 is a diagram that exemplifies a flowchart representing one example of operation of an apparatus for retina drawing and displaying;

FIG. 5 is an operation state diagram;

FIG. 6 is a diagram that exemplifies a timing chart of operation of an apparatus for retina drawing and displaying;

FIG. 7A is a diagram that exemplifies an image recognized by a user when scattered light is not being detected, and FIG. 7B is a diagram that exemplifies a scene recognized by a user when scattered light is being detected;

FIG. 8A to FIG. 8C are diagrams that exemplify a procedure of stopping a mirror;

FIG. 9 is a diagram that exemplifies a flowchart representing another example of operation of an apparatus for retina drawing and displaying;

FIG. 10 is a diagram that exemplifies an overall configuration of an apparatus for retina drawing and displaying according to embodiment example 2;

FIG. 11A is a diagram that exemplifies positions of markers in an image, and FIG. 11B to FIG. 11D are diagrams that exemplify a relationship between a pupil range and markers;

FIG. 12A to FIG. 12E are diagrams that exemplify detection of markers;

FIG. 13 is a diagram that exemplifies a flowchart representing one example of operation of an apparatus for retina drawing and displaying;

FIG. 14 is an operation state diagram;

FIG. 15 is a diagram that exemplifies a timing chart of operation of an apparatus for retina drawing and displaying;

FIG. 16 is a diagram that exemplifies a flowchart representing another example of operation of an apparatus for retina drawing and displaying;

FIG. 17 is an operation state diagram;

FIG. 18A is a diagram that exemplifies a case in which an infrared ray is used, and FIG. 18B is a diagram that exemplifies drawing and displaying by an infrared ray; and

FIG. 19 is a diagram that exemplifies another hardware configuration.

### DESCRIPTION OF EMBODIMENTS

In the related art, drawing light with which a retina is irradiated is emitted to the inside of an eyeball through an optical system that once converges the drawing light in the vicinity of a pupil. Therefore, when the line of sight moves and the position of the pupil moves, the drawing light does not pass through the pupil and thus an image is not recognized by the user. If drawing and displaying are carried out also when an image is not recognized by the user, the power of the apparatus for retina drawing and displaying is uselessly consumed.

As one aspect of the present embodiment, provided are solutions for being able to suppress the power consumption of an apparatus for image display.

Embodiment examples will be described below with reference to the drawings.

### Embodiment Example 1

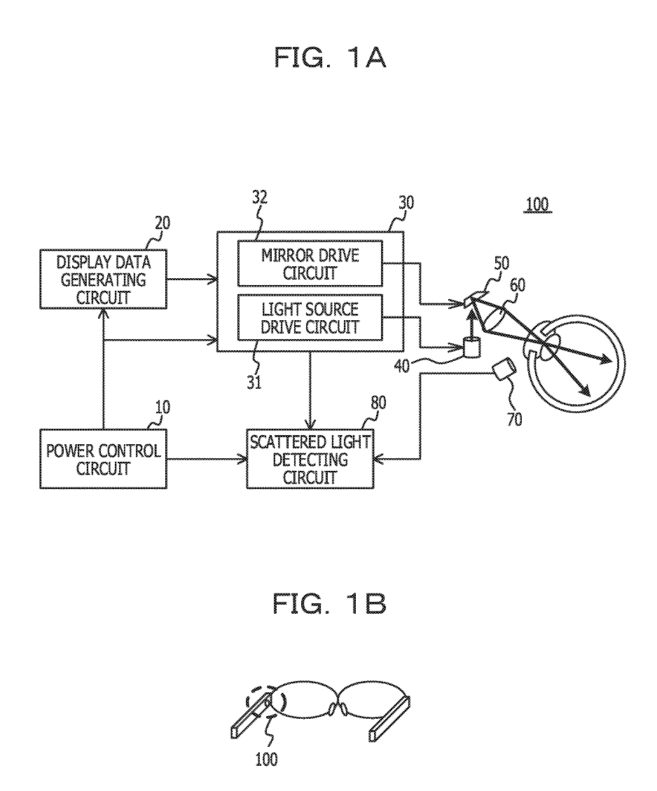

FIG. 1A is a diagram that exemplifies an overall configuration of an apparatus for image display (e.g. retina drawing and displaying) according to embodiment example 1. FIG. 1B is a diagram that exemplifies disposing of an apparatus for image display. As exemplified in FIG. 1A, an apparatus for image display 100 includes a power control circuit 10, a display data generating circuit 20, a display device 30, a light source 40, a mirror 50, a lens 60, a scattered light detector 70, a scattered light detecting circuit 80, and so forth. The display device 30 includes a light source drive circuit 31 and a mirror drive circuit 32. As exemplified in FIG. 1B, the apparatus for image display 100 is disposed at a part other than the lenses of eyeglasses (for example, temple part). Below, the apparatus for image display 100 is also called as an apparatus for retina drawing and displaying.

The power control circuit 10 controls On and Off of power supply to the display data generating circuit 20, the display device 30, and the scattered light detecting circuit 80. Thereby, the power control circuit 10 controls activation and stop of the display data generating circuit 20, the display device 30, and the scattered light detecting circuit 80. The display data generating circuit 20 generates display data that forms an image to be recognized by a user. For example, the display data generating circuit 20 generates information on each position on a retina and color information (for example, red, green and blue (RGB)) of light made incident on the relevant position as the display data. For example, the position information of the retina and the color information of the light associated with this position information are included in the display data.

The light source 40 includes three semiconductor lasers for RGB for example. The mirror 50 is a mirror that polarizes light emitted from the light source 40 to make the light incident on a retina. The mirror 50 is a scanner mirror whose angle can be varied and is a micro electro mechanical system (MEMS) mirror for example. The light reflected by the mirror 50 is collected by the lens 60 and is irradiated to the retina.

The light source drive circuit 31 drives the light source 40 so that light with the color corresponding to the display data generated by the display data generating circuit 20 may be emitted. The light emitted from the light source 40 corresponding to the display data will be referred to as drawing light hereinafter. The mirror drive circuit 32 drives the mirror 50 so that the drawing light may be incident on the position on the retina indicated by the position information of the display data. By the operation of the light source drive circuit 31 and the mirror drive circuit 32, the display data generated by the display data generating circuit 20 is drawn and displayed on the retina. Thereby, the display data is recognized by the user as an image.

The scattered light detector 70 detects scattered light generated due to reflection of the drawing light around a pupil. The scattered light detector 70 is a photodiode or the like. Because the output power of the scattered light detector 70 becomes higher due to the detection of the scattered light, the scattered light detecting circuit 80 determines whether or not the scattered light is being detected according to the output power of the scattered light detector 70.

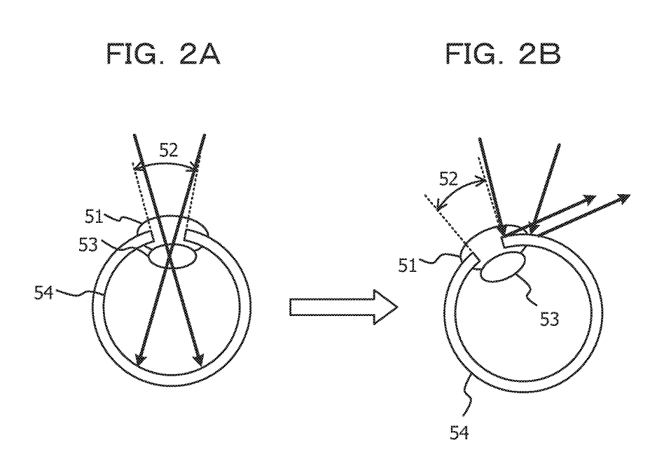

FIG. 2A and FIG. 2B are diagrams that exemplify irradiation with drawing light. As exemplified in FIG. 2A, drawing light from the mirror 50 passes through a pupil 52 in an iris 51 and passes through a crystalline lens 53 to be irradiated to a retina 54. The position of the irradiation of the retina 54 with the drawing light from the mirror 50 is determined by the mirror 50. As exemplified in FIG. 2B, when the user moves the line of sight, the drawing light from the mirror 50 is not incident on the pupil 52 but reflected around the pupil 52. Thereby, scattered light is incident on the scattered light detector 70. In this case, the scattered light detecting circuit 80 detects the scattered light.

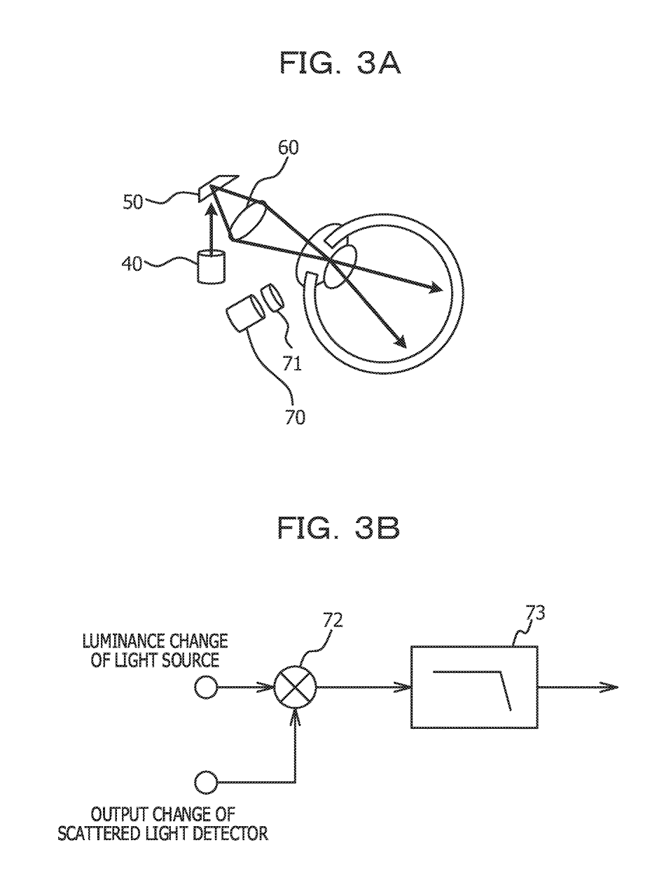

FIG. 3A and FIG. 3B are diagrams that exemplify scattered light detection mechanisms included in a scattered light detector. Incidentally, the scattered light detector in FIG. 3A and FIG. 3B may be the scattered light detector 70 in FIG. 1A. As exemplified in FIG. 3A, by providing the scattered light detector 70 with a band-pass filter 71 that selectively allows passing of light with the emission wavelength of the light source 40, disturbance due to light from the external can be reduced. Alternatively, as exemplified in FIG. 3B, scattered light may be detected by using a lock-in amplifier that uses information on luminance change of the light source 40 and output change of the scattered light detector 70. For example, the luminance change of the light source 40 and light intensity detected by the scattered light detector 70 are multiplied by a multiplier 72 and filtering is carried out on the obtained result by a low-pass filter 73. This can detect weak light such as scattered light.

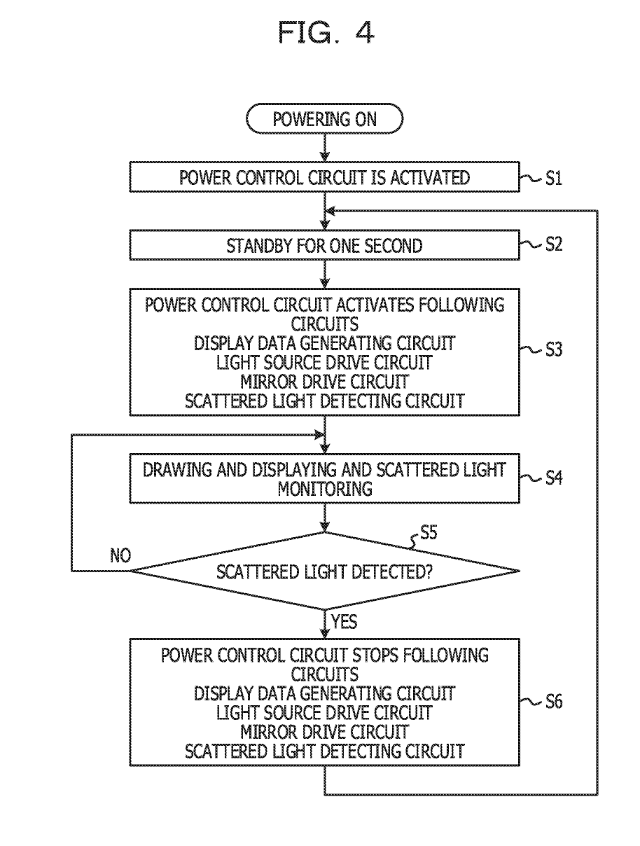

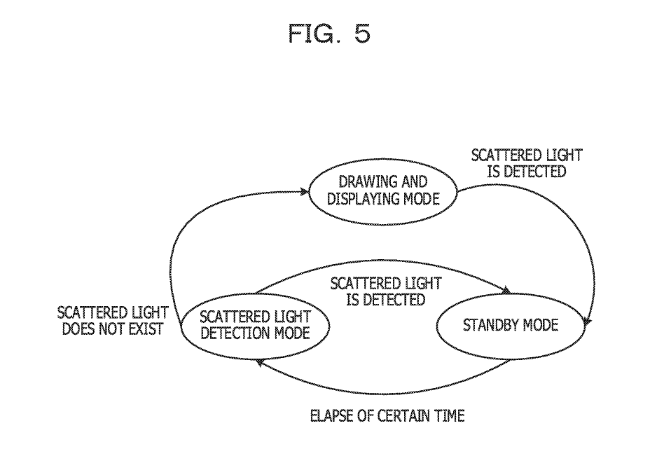

FIG. 4 is a diagram that exemplifies a flowchart representing one example of operation of an apparatus for retina drawing and displaying. Incidentally, the apparatus for retina drawing and displaying in FIG. 4 may be the apparatus for retina drawing and displaying 100 in FIG. 1A. FIG. 5 is an operation state diagram. As exemplified in FIG. 4, when the power control circuit 10 is activated (step S1), the power control circuit 10 enters the standby state (step S2). The step S2 corresponds to a standby mode in FIG. 5. The standby time is one second for example. Next, the power control circuit 10 activates the display data generating circuit 20, the light source drive circuit 31, the mirror drive circuit 32, and the scattered light detecting circuit 80 (step S3). The display data generating circuit 20 generates display data. By the light source drive circuit 31 and the mirror drive circuit 32, drawing and displaying are carried out on a retina in accordance with the display data generated by the display data generating circuit 20. The step S3 corresponds to a drawing and displaying mode in FIG. 5. Furthermore, the scattered light detecting circuit 80 monitors the detection result of the scattered light detector 70 (step S4).

Next, the scattered light detecting circuit 80 determines whether or not scattered light is detected by the scattered light detector 70 (step S5). The step S4 and the step S5 correspond to a scattered light detection mode in FIG. 5. If the determination result is “No” in the step S5, the operation is carried out from the step S4 again. If the determination result is “Yes” in the step S5, the power control circuit 10 stops the display data generating circuit 20, the light source drive circuit 31, the mirror drive circuit 32, and the scattered light detecting circuit 80 (step S6). Thereafter, the operation is carried out from the step S2 again.

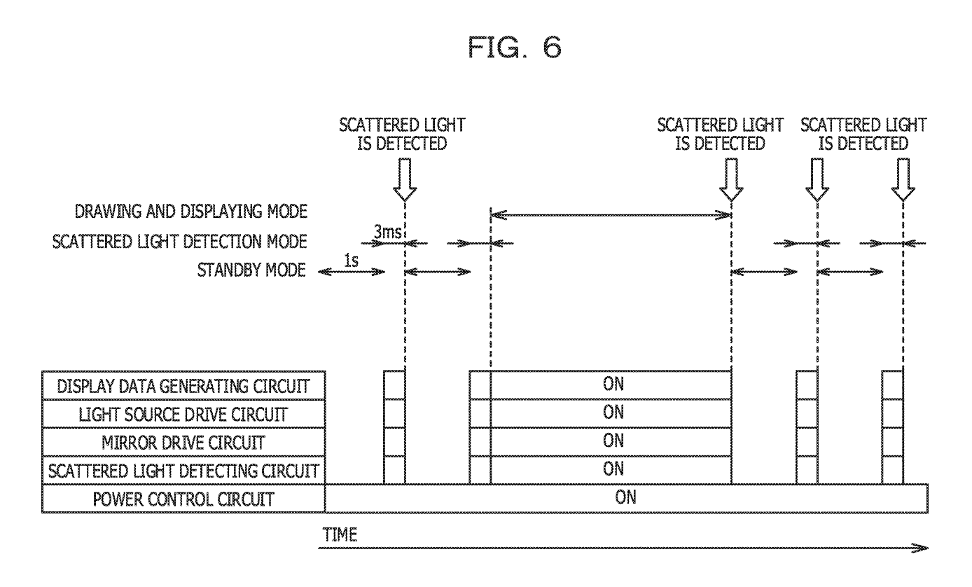

FIG. 6 is a diagram that exemplifies a timing chart of the operation of an apparatus for retina drawing and displaying. Incidentally, the apparatus for retina drawing and displaying in FIG. 6 may be the apparatus for retina drawing and displaying 100 in FIG. 1A. As exemplified in FIG. 6, when being activated (turned On), the power control circuit 10 keeps the On-state until being turned Off. After the power control circuit 10 is activated, the operation mode is the standby mode for one second. When the standby mode ends, the power control circuit 10 activates the display data generating circuit 20, the light source drive circuit 31, the mirror drive circuit 32, and the scattered light detecting circuit 80. When the scattered light detecting circuit 80 carries out determination of scattered light detection (for example after 3 ms), the power control circuit 10 stops the display data generating circuit 20, the light source drive circuit 31, the mirror drive circuit 32, and the scattered light detecting circuit 80 and the operation mode becomes the standby mode. When the standby mode ends, the power control circuit 10 activates the display data generating circuit 20, the light source drive circuit 31, the mirror drive circuit 32, and the scattered light detecting circuit 80 again. From then on, similar processing is carried out.

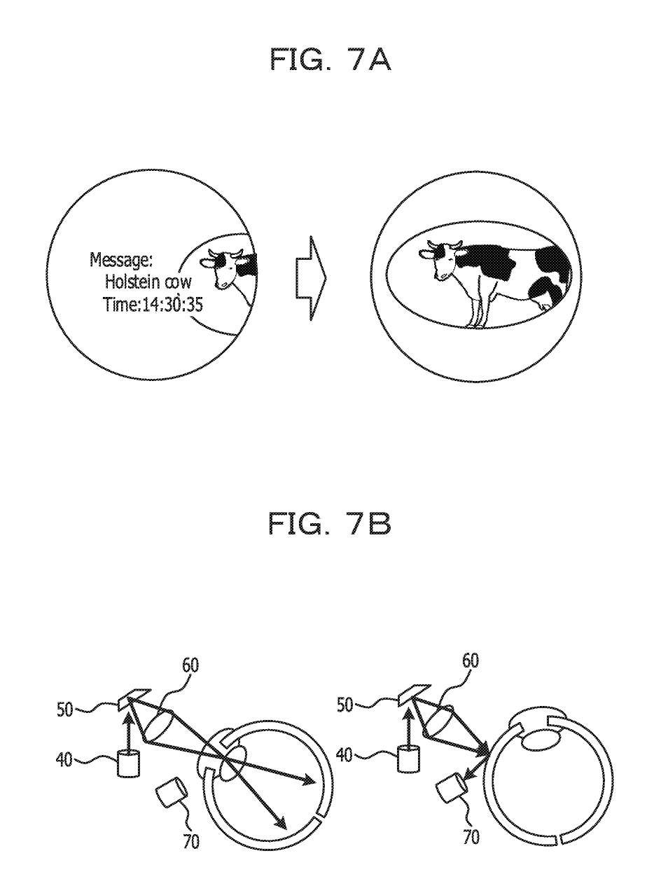

FIG. 7A is a diagram that exemplifies an image recognized by a user when scattered light is not being detected. As exemplified in FIG. 7A, when the user orients the line of sight toward a temple of the eyeglasses, drawing light from the mirror 50 passes through a pupil and is incident on a retina. In this case, the scattered light is not detected. Therefore, the user recognizes the image in accordance with the display data generated by the display data generating circuit 20. In the example of FIG. 7A, a message and the time are displayed.

FIG. 7B is a diagram that exemplifies a scene recognized by a user when scattered light is being detected. As exemplified in FIG. 7B, when the user diverts the line of sight into the lens direction, the reflected light from the mirror 50 is not incident on the pupil but reflected. Thereby, the scattered light is detected and drawing and displaying on the retina of the user are stopped. From the above, it suffices for the user to orient the line of sight toward the temple when desiring information and so forth. When the user orients the line of sight in an ordinary direction such as the lens direction, drawing and displaying are stopped.

According to the present embodiment example, scattered light when the user diverts the line of sight and drawing light from the mirror 50 is reflected around a pupil is detected by the scattered light detecting circuit 80. When the scattered light is detected, the display data generating circuit 20, the light source drive circuit 31, the mirror drive circuit 32, and the scattered light detecting circuit 80 are stopped. Thereby, the power consumption is suppressed.

### Modification Example 1

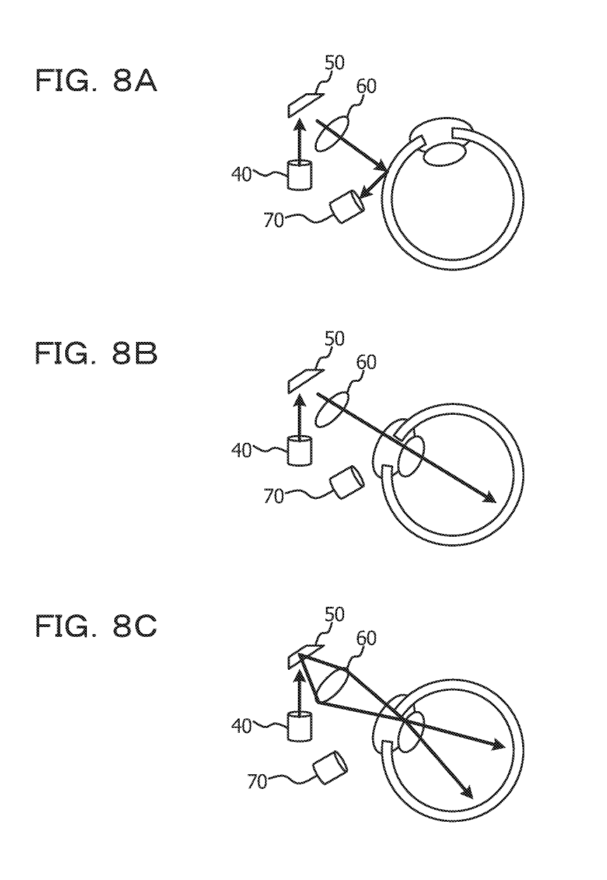

When driving of the mirror 50 is stopped, the orientation of drawing light from the mirror 50 is set to be located in an image (for example, at the center of the image). Due to this, the mirror 50 does not have to be driven at the initial timing of drawing and displaying. This can realize further reduction in the power consumption. FIG. 8A to FIG. 8C are diagrams that exemplify a procedure of stopping a mirror. Incidentally, the mirror in FIG. 8A to FIG. 8C may be the mirror 50 in FIG. 1A.

FIG. 8A exemplifies the case in which scattered light is detected and drawing and displaying are stopped. In this case, the power control circuit 10 stops the mirror drive circuit 32 after the mirror drive circuit 32 drives the mirror 50 in such a manner that the orientation of drawing light from the mirror 50 is located at the center of the image. As exemplified in FIG. 8B, drawing and displaying are started after scattered light becomes undetected in this state. Because the angle of the mirror drive circuit 32 is so set that the orientation of the drawing light is located at the center of the image, the mirror 50 does not have to be driven at this timing.

Next, the display data generating circuit 20 generates display data of an image whose range is small (for example, dot image). If scattered light is not detected when the dot image is drawn and displayed by the light source drive circuit 31 and the mirror drive circuit 32, it is inferred that the image falls within the pupil range across the whole range as exemplified in FIG. 8C. By thereafter starting drawing and displaying, unnecessary driving of the mirror 50 can be suppressed.

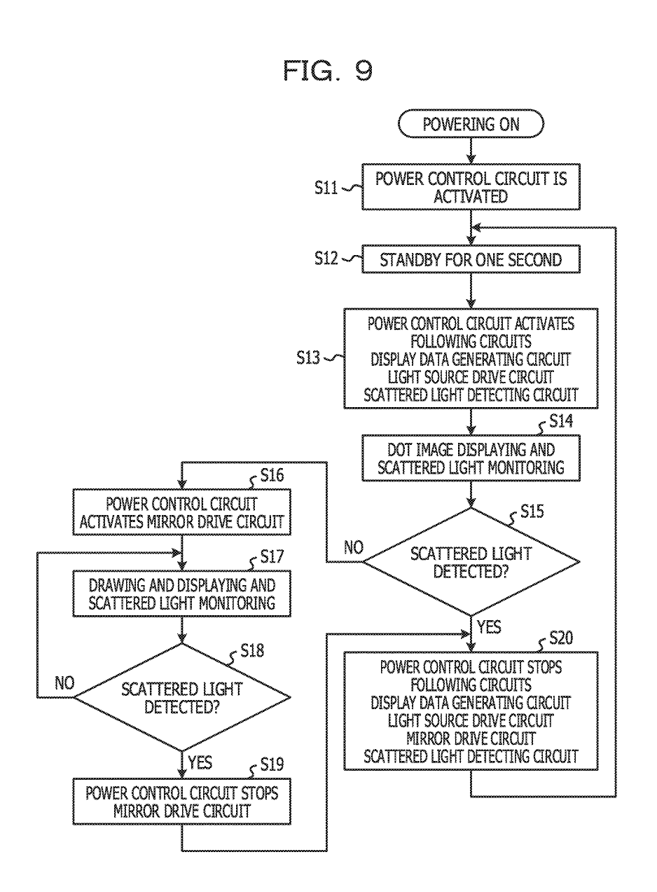

FIG. 9 is a diagram that exemplifies a flowchart representing another example of operation of an apparatus for retina drawing and displaying. Incidentally, the apparatus for retina drawing and displaying in FIG. 9 may be the apparatus for retina drawing and displaying 100 in FIG. 1A. As exemplified in FIG. 9, when the power control circuit 10 is activated (step S11), the power control circuit 10 enters the standby state (step S12). The standby time is one second for example. Next, the power control circuit 10 activates the display data generating circuit 20, the light source drive circuit 31, and the scattered light detecting circuit 80 (step S13). Thereby, the display data generating circuit 20 generates display data of a dot image. At this timing, the angle of the mirror 50 is so set that drawing light is oriented toward the center of an image. The dot image generated by the display data generating circuit 20 is drawn and displayed on a retina by the light source drive circuit 31. Furthermore, the scattered light detecting circuit 80 monitors the detection result of the scattered light detector 70 (step S14).

Next, the scattered light detecting circuit 80 determines whether or not scattered light is detected by the scattered light detector 70 (step S15). If the determination result is “No” in the step S15, the power control circuit 10 activates the mirror drive circuit 32 (step S16). Next, the display data generating circuit 20 generates display data. The display data generated by the display data generating circuit 20 is drawn and displayed on the retina by the light source drive circuit 31 and the mirror drive circuit 32. Furthermore, the scattered light detecting circuit 80 monitors the detection result of the scattered light detector 70 (step S17).

Next, the scattered light detecting circuit 80 determines whether or not scattered light is detected by the scattered light detector 70 (step S18). If the determination result is “No” in the step S18, the operation is carried out from the step S17 again. If the determination result is “Yes” in the step S18, the power control circuit 10 stops the mirror drive circuit 32 (step S19). After the step S19 is carried out or if the determination result is “Yes” in the step S15, the power control circuit 10 stops the display data generating circuit 20, the light source drive circuit 31, the mirror drive circuit 32, and the scattered light detecting circuit 80 (step S20). In the step S20, the power control circuit 10 stops the mirror drive circuit 32 after the mirror drive circuit 32 drives the mirror 50 in such a manner that the drawing light from the mirror 50 is oriented toward the center of the image. Thereafter, the operation is carried out from the step S12 again.

### Embodiment Example 2

In the case of attempting to display all of display data generated by the display data generating circuit 20, the angle of the mirror 50 is sequentially changed. In this case, even when drawing light from the mirror 50 passes through a pupil at given timing, the drawing light corresponding to part of the display data does not pass through the pupil and is detected as scatted light in some cases. For example, when the pupil moves little by little due to the movement of the line of sight, part of the drawing light does not pass through the pupil and part of the image corresponding to the display data is not displayed. For example, there is also the case in which a misunderstanding is caused depending on the contents of the displaying. In embodiment example 2, description will be made about an example in which drawing and displaying are stopped if a missing part of the image corresponding to display data is generated.

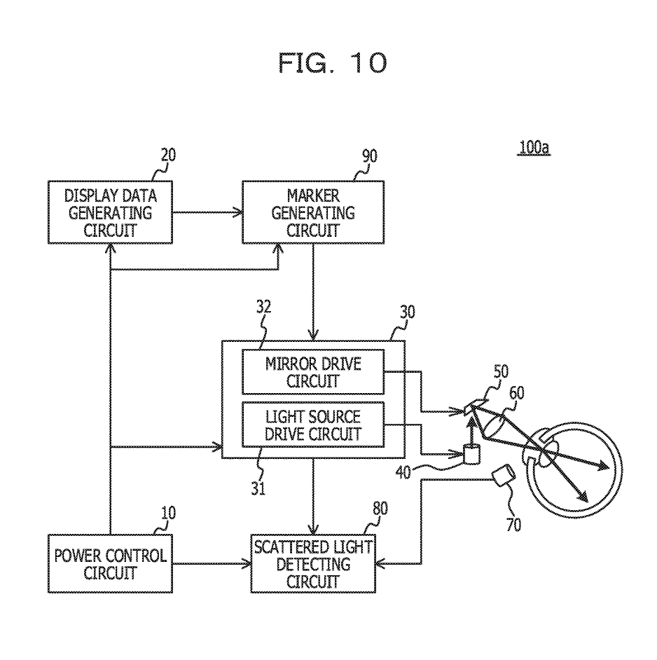

FIG. 10 is a diagram that exemplifies an overall configuration of an apparatus for retina drawing and displaying according to embodiment example 2. As exemplified in FIG. 10, an apparatus for retina drawing and displaying 100a is different from the apparatus for retina drawing and displaying 100 according to embodiment example 1 in that a marker generating circuit 90 is further included.

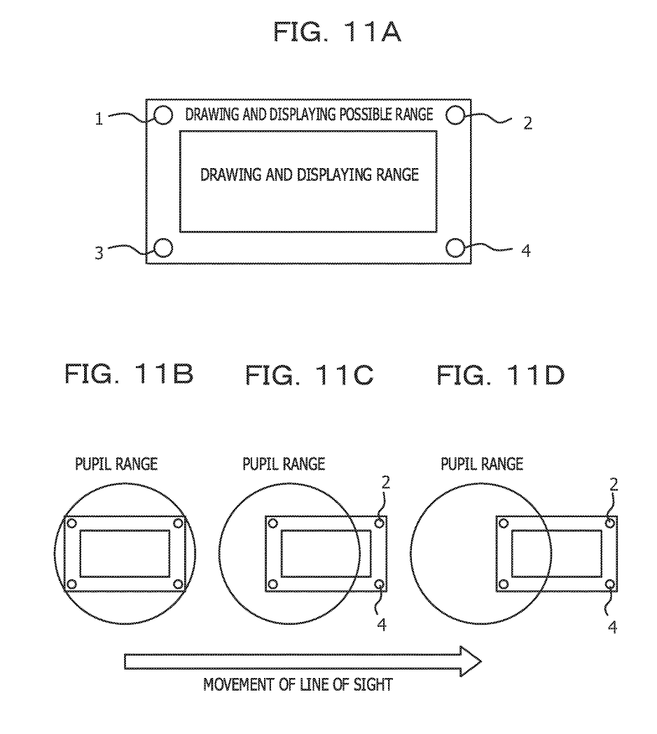

The marker generating circuit 90 displays markers 1 to 4 as partial drawing in an image recognized by a user. For example, the marker generating circuit 90 displays the markers 1 to 4 outside the drawing and displaying range for being recognized by the user and in the range in which drawing and displaying by the mirror 50 are possible. FIG. 11A is a diagram that exemplifies positions of markers in an image. In the example of FIG. 11A, the markers 1 to 4 are disposed at four corners of the image. FIG. 11B is a diagram of the case in which four markers 1 to 4 are located in the pupil range. When the line of sight of the user moves, part of the markers (markers 2 and 4) get out of the pupil range as exemplified in FIG. 11C and FIG. 11D. In the present embodiment example, drawing and displaying are stopped in the cases of FIG. 11C and FIG. 11D.

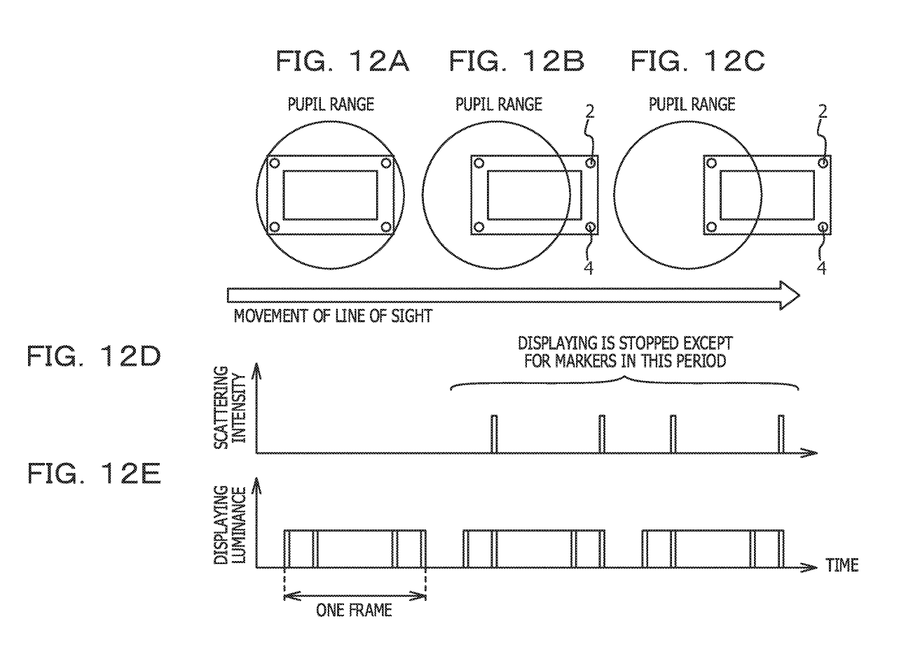

FIG. 12A to FIG. 12E are diagrams that exemplify detection of markers. FIG. 12A to FIG. 12C are the similar to FIG. 11B to FIG. 11D. The mirror 50 forms an image by scanning the position of incidence of drawing light on a retina. Therefore, a given time is taken when the image is formed. The time it takes to form one image will be referred to as one frame.

As exemplified in FIG. 12E, drawing light corresponding to the markers 1 to 4 is emitted four times in one frame. For example, the drawing light is emitted at given time intervals. In the example of FIG. 12A, four markers 1 to 4 fall within the pupil range. In this case, when the drawing light corresponding to the markers 1 to 4 is emitted, scattered light is not detected as exemplified in FIG. 12D. In contrast, in the examples of FIG. 12B and FIG. 12C, two markers 2 and 4 get out of the pupil range. In this case, as exemplified in FIG. 12D, scattered light is detected at the timing when the drawing light corresponding to the markers 2 and 4 is emitted. From the above, it suffices to stop drawing and displaying if scattered light is detected when the markers 1 to 4 are drawn and displayed.

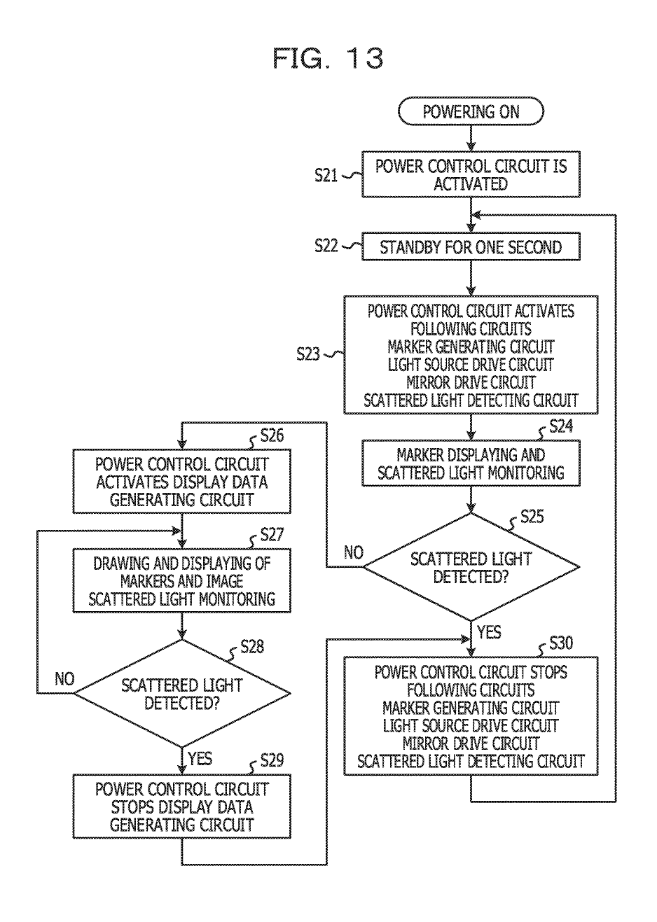

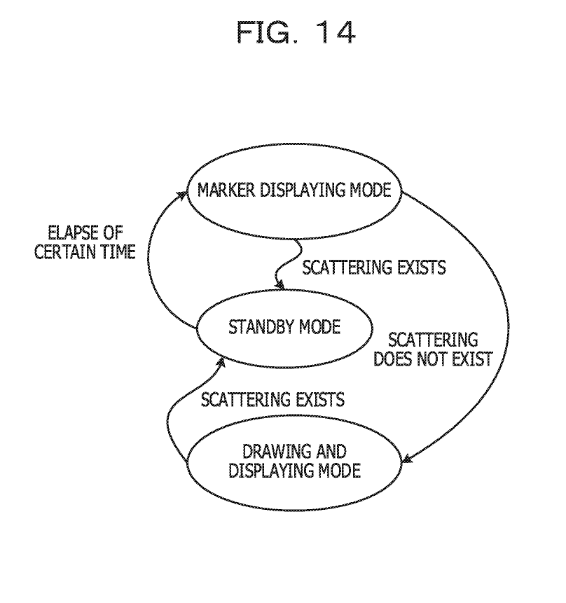

FIG. 13 is a diagram that exemplifies a flowchart representing one example of operation of an apparatus for retina drawing and displaying. Incidentally, the apparatus for retina drawing and displaying in FIG. 13 may be the apparatus for retina drawing and displaying 100a in FIG. 10. FIG. 14 is an operation state diagram. As exemplified in FIG. 13, when the power control circuit 10 is activated (step S21), the power control circuit 10 enters the standby state (step S22). The step S22 corresponds to a standby mode in FIG. 14. The standby time is one second for example. Next, the power control circuit 10 activates the marker generating circuit 90, the light source drive circuit 31, the mirror drive circuit 32, and the scattered light detecting circuit 80 (step S23). The marker generating circuit 90 generates display data of markers. By the light source drive circuit 31 and the mirror drive circuit 32, the display data of the markers 1 to 4 generated by the marker generating circuit 90 are drawn and displayed on a retina. The step S23 corresponds to a marker displaying mode in FIG. 14. Furthermore, the scattered light detecting circuit 80 monitors the detection result of the scattered light detector 70 (step S24).

Next, the scattered light detecting circuit 80 determines whether or not scattered light is detected by the scattered light detector 70 (step S25). If the determination result is “No” in the step S25, the power control circuit 10 activates the display data generating circuit 20 (step S26). Next, the display data generating circuit 20 generates display data. By the light source drive circuit 31 and the mirror drive circuit 32, the display data of the markers 1 to 4 generated by the marker generating circuit 90 and an image in accordance with the display data generated by the display data generating circuit 20 are drawn and displayed on the retina. Furthermore, the scattered light detecting circuit 80 monitors the detection result of the scattered light detector 70 (step S27). The step S27 corresponds to a drawing and displaying mode in FIG. 14.

Next, the scattered light detecting circuit 80 determines whether or not scattered light is detected by the scattered light detector 70 (step S28). If the determination result is “No” in the step S28, the operation is carried out from the step S27 again. If the determination result is “Yes” in the step S28, the power control circuit 10 stops the display data generating circuit 20 (step S29). After the step S29 is carried out or if the determination result is “Yes” in the step S25, the power control circuit 10 stops the marker generating circuit 90, the light source drive circuit 31, the mirror drive circuit 32, and the scattered light detecting circuit 80 (step S30). Thereafter, the operation is carried out from the step S22 again.

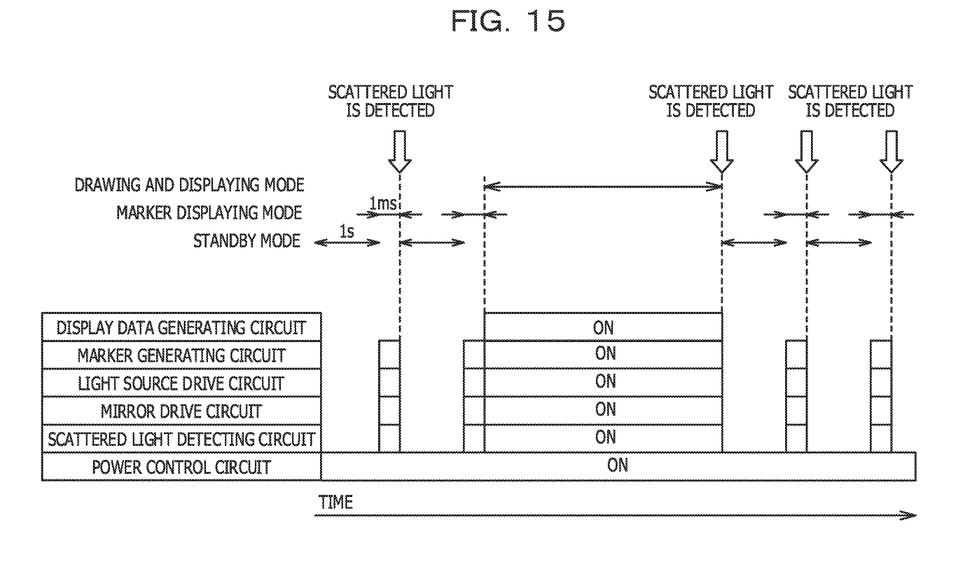

FIG. 15 is a diagram that exemplifies a timing chart of operation of an apparatus for retina drawing and displaying. Incidentally, the apparatus for retina drawing and displaying in FIG. 15 may be the apparatus for retina drawing and displaying 100a in FIG. 10. As exemplified in FIG. 15, when being activated (turned On), the power control circuit 10 keeps the On-state until being turned Off. After the power control circuit 10 is activated, the operation mode is the standby mode for one second. When the standby mode ends, the power control circuit 10 activates the marker generating circuit 90, the light source drive circuit 31, the mirror drive circuit 32, and the scattered light detecting circuit 80. When the scattered light detecting circuit 80 carries out determination of scattered light detection, the power control circuit 10 stops the marker generating circuit 90, the light source drive circuit 31, the mirror drive circuit 32, and the scattered light detecting circuit 80 and the operation mode becomes the standby mode. When the standby mode ends, the power control circuit 10 activates the marker generating circuit 90, the light source drive circuit 31, the mirror drive circuit 32, and the scattered light detecting circuit 80 again. If scattered light is not detected after the reactivation, the power control circuit 10 further activates the display data generating circuit 20. If thereafter scattered light is detected, the power control circuit 10 stops the display data generating circuit 20, the marker generating circuit 90, the light source drive circuit 31, the mirror drive circuit 32, and the scattered light detecting circuit 80 and the operation mode becomes the standby mode. From then on, similar processing is carried out.

According to the present embodiment example, scattered light when the user diverts the line of sight and drawing light from the mirror 50 is reflected around a pupil is detected by the scattered light detecting circuit 80. When the scattered light is detected, the display data generating circuit 20, the marker generating circuit 90, the light source drive circuit 31, the mirror drive circuit 32, and the scattered light detecting circuit 80 are stopped. Thereby, the power consumption is suppressed. Furthermore, drawing and displaying are carried out after it is confirmed that scattered light of none of the markers 1 to 4 is detected. This can keep the completeness of the image recognized by the user.

### Modification Example 2

To carry out drawing and displaying when a user unintentionally moves the line of sight becomes troublesome depending on the case. Then, a configuration may be employed in which drawing and displaying are carried out when a user gazes at the side of the apparatus for retina drawing and displaying 100a for a certain time.

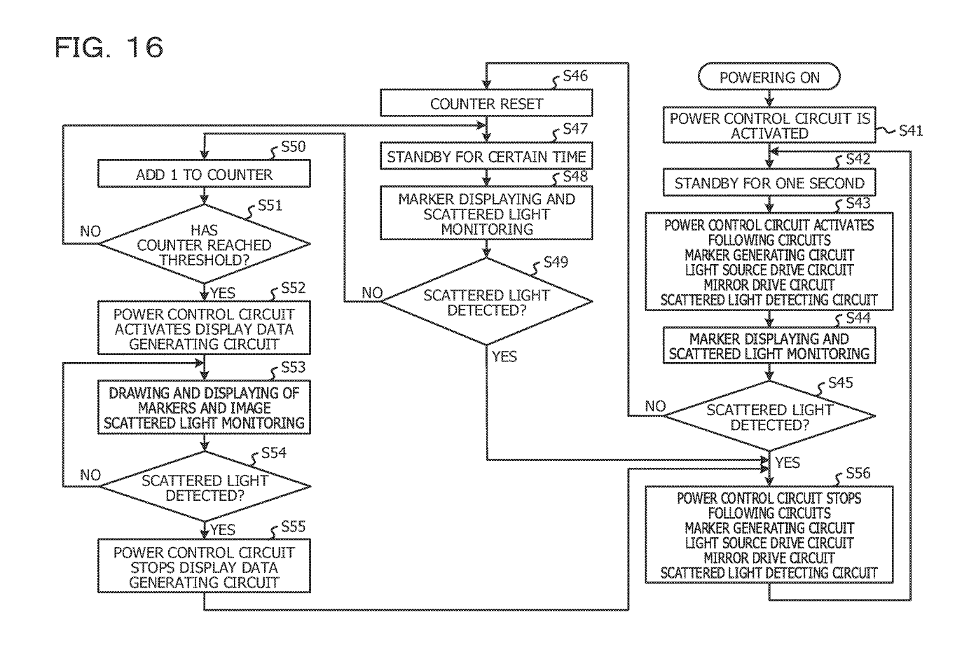

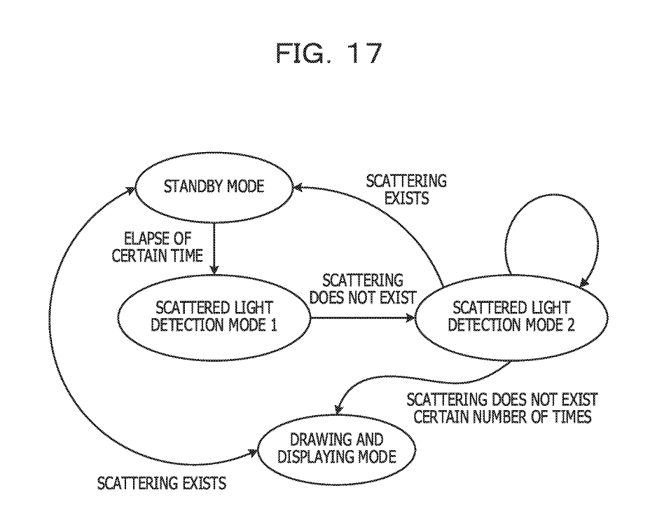

FIG. 16 is a diagram that exemplifies a flowchart representing another example of operation of an apparatus for retina drawing and displaying. Incidentally, the apparatus for retina drawing and displaying in FIG. 16 may be the apparatus for retina drawing and displaying 100a in FIG. 10. FIG. 17 is an operation state diagram. As exemplified in FIG. 16, when the power control circuit 10 is activated (step S41), the power control circuit 10 enters the standby state (step S42). The step S42 corresponds to a standby mode in FIG. 17. The standby time is one second for example. Next, the power control circuit 10 activates the marker generating circuit 90, the light source drive circuit 31, the mirror drive circuit 32, and the scattered light detecting circuit 80 (step S43). The marker generating circuit 90 generates display data of the markers 1 to 4. By the light source drive circuit 31 and the mirror drive circuit 32, the display data of the markers 1 to 4 generated by the marker generating circuit 90 are drawn and displayed on a retina. Furthermore, the scattered light detecting circuit 80 monitors the detection result of the scattered light detector 70 (step S44).

Next, the scattered light detecting circuit 80 determines whether or not scattered light is detected by the scattered light detector 70 (step S45). The step S44 and the step S45 correspond to scattered light detection mode 1 in FIG. 17. If the determination result is “No” in the step S45, the power control circuit 10 resets a counter (step S46). Next, the power control circuit 10 is in the standby state for a certain time (step S47). The step S47 corresponds to the standby mode in FIG. 17. The certain time is one second for example. Next, the marker generating circuit 90 generates display data of the markers 1 to 4. By the light source drive circuit 31 and the mirror drive circuit 32, the display data of the markers 1 to 4 generated by the marker generating circuit 90 are drawn and displayed on the retina. Furthermore, the scattered light detecting circuit 80 monitors the detection result of the scattered light detector 70 (step S48).

Next, the scattered light detecting circuit 80 determines whether or not scattered light is detected by the scattered light detector 70 (step S49). If the determination result is “No” in the step S49, the power control circuit 10 adds 1 to the counter (step S50). Next, the power control circuit 10 determines whether or not the counter has reached a threshold (step S51). If the determination result is “No” in the step S51, the operation is carried out from the step S47 again. The step S47 to the step S51 correspond to scattered light detection mode 2 in FIG. 17.

If the determination result is “Yes” in the step S51, the power control circuit 10 activates the display data generating circuit 20 (step S52). Thereby, the display data generating circuit 20 generates display data. By the light source drive circuit 31 and the mirror drive circuit 32, the display data of the markers 1 to 4 generated by the marker generating circuit 90 and an image in accordance with the display data generated by the display data generating circuit 20 are drawn and displayed on the retina. Furthermore, the scattered light detecting circuit 80 monitors the detection result of the scattered light detector 70 (step S53). The step S53 corresponds to a drawing and displaying mode in FIG. 17.

Next, the scattered light detecting circuit 80 determines whether or not scattered light is detected by the scattered light detector 70 (step S54). If the determination result is “No” in the step S54, the operation is carried out from the step S53 again. If the determination result is “Yes” in the step S54, the power control circuit 10 stops the display data generating circuit 20 (step S55). After the step S55 is carried out or if the determination result is “Yes” in the step S45 or if the determination result is “Yes” in the step S49, the power control circuit 10 stops the marker generating circuit 90, the light source drive circuit 31, the mirror drive circuit 32, and the scattered light detecting circuit 80 (step S56). Thereafter, the operation is carried out from the step S42 again.

According to the present modification example, drawing and displaying are carried out after it is confirmed that scattered light is not detected until the counter reaches the threshold. Due to this, drawing and displaying are carried out after it is confirmed that the user has gazed at the side of the apparatus for retina drawing and displaying 100a for the certain time. Thereby, that the processing of the apparatus for retina drawing and displaying 100a becomes troublesome is suppressed.

### Modification Example 3

Drawing and displaying by use of an infrared ray as a marker may be carried out. For example, drawing and displaying by an infrared ray may be carried out outside the drawing and displaying range for being recognized by the user and in the range in which drawing and displaying by the mirror 50 are possible. This can carry out drawing and displaying of the marker without recognition by the user.

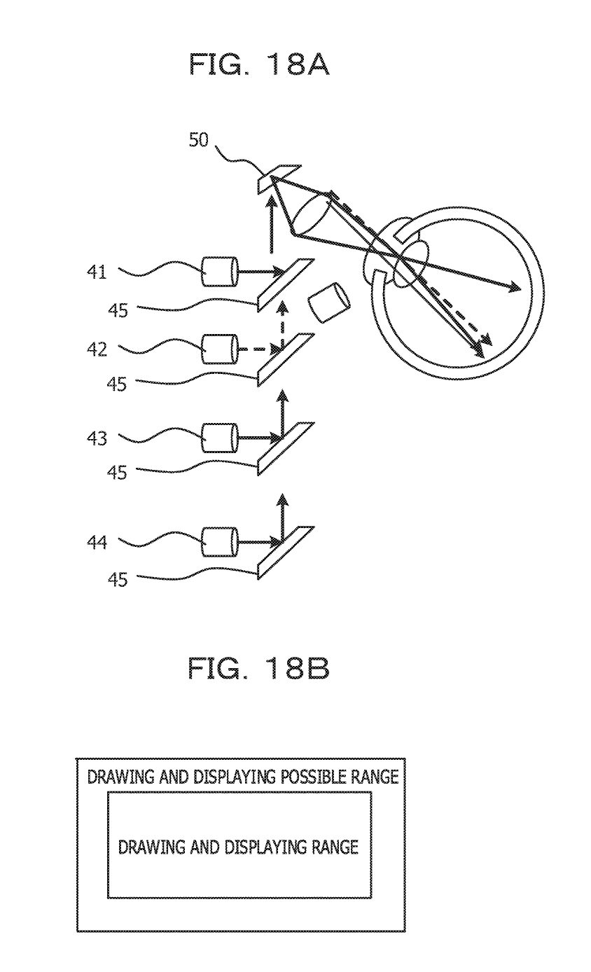

FIG. 18A is a diagram that exemplifies a case in which an infrared ray is used. As exemplified in FIG. 18A, a light source 44 for the infrared ray is provided in addition to a light source 41 for red, a light source 42 for blue, and a light source 43 for green. Light beams emitted from the light sources 41 to 44 are reflected to the mirror 50 by half mirrors 45. As exemplified in FIG. 18B, drawing and displaying by an infrared ray are carried out outside the drawing and displaying range and in the range in which drawing and displaying by the mirror 50 are possible. Because the user does not recognize the infrared ray, drawing and displaying of the marker can be carried out without recognition by the user.

### OTHER EXAMPLES

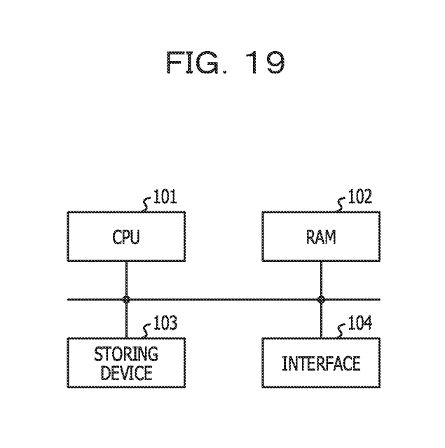

The power control circuit 10, the display data generating circuit 20, the display device 30, the scattered light detecting circuit 80, and the marker generating circuit 90 may have a hardware configuration other than the circuit. For example, the power control circuit 10, the display data generating circuit 20, the display device 30, the scattered light detecting circuit 80, and the marker generating circuit 90 may be alternated with equivalent functions implemented by execution of a program. FIG. 19 is a block diagram for explaining one example of a hardware configuration. As exemplified in FIG. 19, a central processing unit (CPU) 101, a random access memory (RAM) 102, a storing device 103, an interface 104, and so forth may be included in place of the power control circuit 10, the display data generating circuit 20, the display device 30, the scattered light detecting circuit 80, and the marker generating circuit 90. These respective pieces of equipment are coupled by a bus or the like. The CPU 101 is a central arithmetic processing device. The CPU 101 includes one or more cores. The RAM 102 is a volatile memory that temporarily stores a program executed by the CPU 101, data processed by the CPU 101, and so forth. The storing device 103 is a non-volatile storing device. As the storing device 103, a read only memory (ROM), a solid state drive (SSD) such as a flash memory, a hard disk driven by a hard disk drive, or the like can be used for example. Functions equivalent to the power control circuit 10, the display data generating circuit 20, the display device 30, the scattered light detecting circuit 80, and the marker generating circuit 90 may be implemented through execution of a program stored in the storing device 103 by the CPU 101.

In the above-described respective examples, the display device 30, the light source 40, and the mirror 50 function as one example of a drawing circuit that carries out drawing processes which include irradiating a retina with light through a pupil. The scattered light detector 70 functions as one example of a detector that detects scattered light generated due to reflection of light emitted by the drawing circuit around the pupil. The power control circuit 10 functions as one example of a stopping circuit that stops the drawing processes performed by the drawing circuit for a given period if the scattered light is detected by the detector.

Although embodiment examples of the present disclosure are described in detail above, the present disclosure is not limited to such specific embodiment examples and various modifications and changes can be made in the range of the gist of the present disclosure set forth in the scope of claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for image display, the apparatus comprising:
a drawing circuit configured to carry out drawing processes which include irradiating a retina with light through a pupil;
a detector configured to detect scattered light generated due to reflection of light emitted by the drawing circuit around the pupil; and
a stopping circuit configured to stop the drawing processes performed by the drawing circuit for a given period when the scattered light is detected by the detector.

2. The apparatus according to claim 1,
wherein the drawing circuit carries out the drawing processes partly to a drawing range of the drawing circuit, and
the stopping circuit stops the drawing processes performed by the drawing circuit for a given period when scattered light generated due to reflection of light used for partial drawing of the drawing circuit around the pupil is detected by the detector.

3. The apparatus according to claim 1,
wherein the drawing processes cause the drawing circuit to emit an infrared ray, and
the stopping circuit stops the drawing processes performed by the drawing circuit for a given period when scattered light generated due to reflection of the infrared ray around the pupil is detected by the detector.

4. The apparatus according to claim 1,
wherein the detector includes a band-pass filter that selectively allows passing of light with a wavelength of light emitted by the drawing circuit.

5. The apparatus according to claim 1,
wherein the detector detects the scattered light by using intensity change of light emitted by the drawing circuit and intensity change of light detected by the detector.

6. A method for image display, the method comprising:
carrying out, by a drawing circuit, drawing processes which include irradiating a retina with light through a pupil;
detecting, by a detector circuit, scattered light generated due to reflection of light emitted by the drawing circuit around the pupil; and
stopping, by a stopping circuit, the drawing processes performed by the drawing circuit for a given period when the scattered light is detected by the detector circuit.

7. The method according to claim 6,
wherein the drawing processes are carried out partly to a drawing range of the drawing circuit, and
the stopping causes the stopping circuit to stop the drawing processes performed by the drawing circuit for a given period when scattered light generated due to reflection of light used for partial drawing of the drawing circuit around the pupil is detected by the detector circuit.

8. The method according to claim 6,
wherein the drawing processes cause the drawing circuit to emit an infrared ray,
the detecting causes the detector circuit to detect scattered light generated due to reflection of the infrared ray around the pupil, and
the stopping causes the stopping circuit to stop the drawing processes performed by the drawing circuit for a given period when scattered light generated due to reflection of the infrared ray around the pupil is detected by the detector circuit.

9. The method according to claim 6,
wherein the detecting causes the detector circuit to use a band-pass filter that selectively allows passing of light with a wavelength of light emitted by the drawing circuit.

10. The method according to claim 6,
wherein the detecting causes the detector circuit to detect the scattered light by using intensity change of light emitted by the drawing circuit and intensity change of light detected by the detector circuit.

11. A non-transitory computer-readable storage medium storing a program that causes a computer to execute a process, the process comprising:
causing a drawing circuit to carry out drawing processes which include irradiating a retina with light through a pupil;
causing a detector circuit to detect scattered light generated due to reflection of light emitted by the drawing circuit around the pupil; and
causing a stopping circuit to stop the drawing processes performed by the drawing circuit for a given period when the scattered light is detected by the detector circuit.

12. The non-transitory computer-readable storage medium according to claim 11,
wherein the drawing processes are carried out partly to a drawing range of the drawing circuit, and
the stopping causes the stopping circuit to stop the drawing processes performed by the drawing circuit for a given period when scattered light generated due to reflection of light used for partial drawing of the drawing circuit around the pupil is detected by the detector circuit.

13. The non-transitory computer-readable storage medium according to claim 11,
wherein the drawing processes cause the drawing circuit to emit an infrared ray,
the detecting causes the detector circuit to detect scattered light generated due to reflection of the infrared ray around the pupil, and
the stopping causes the stopping circuit to stop the drawing processes performed by the drawing circuit for a given period when scattered light generated due to reflection of the infrared ray around the pupil is detected by the detector circuit.

14. The non-transitory computer-readable storage medium according to claim 11,
wherein the detecting causes the detector circuit to use a band-pass filter that selectively allows passing of light with a wavelength of light emitted by the drawing circuit.

15. The non-transitory computer-readable storage medium according to claim 11,
wherein the detecting causes the detector circuit to detect the scattered light by using intensity change of light emitted by the drawing circuit and intensity change of light detected by the detector circuit.
